(19) United States
(12) Patent Application Publication
(10) Pub. No.: US 2014/0207923 A1
(43) Pub. Date: Jul. 24, 2014

(54) METHOD AND A CONTROLLER SYSTEM FOR CONTROLLING A SOFTWARE-DEFINED NETWORK

(71) Applicant: TELLABS OY, ESPOO (FI)

(72) Inventors: Hannu JOKINEN, ESPOO (FI); Ville HALLIVUORI, ESPOO (FI); Juha-Petteri NIEMINEN, ESPOO (FI)

(73) Assignee: TELLABS OY, ESPOO (FI)

(21) Appl. No.: 14/157,943

(22) Filed: Jan. 17, 2014

(30) Foreign Application Priority Data
Jan. 21, 2013 (FI) 20135058

(51) Int. Cl. H04L 12/24

(52) U.S. Cl. CPC H04L 41/082
USPC 709/221

(57) ABSTRACT

A method for controlling a software-defined network “SDN” includes receiving (301) information provided by one or more external sources outside the software-defined network, generating (303) configuration data for changing configuration of one or more network elements of the software-defined network on the basis of the received information in response to a situation (302) where the received information indicates an occurred or forthcoming change of one or more operating conditions of the software-defined network, and sending (304) the configuration data to the network elements so as to adapt the software-defined network to changes of the one or more operating conditions. Therefore, the configuration capabilities provided by the software-defined networking are utilized for dynamically optimizing the software-defined network with respect to changes that are not necessarily indicated by information gathered inside the software-defined network but by information provided by the external sources outside the software-defined network.

### FIELD OF THE INVENTION

The invention relates generally to software-defined networking. More particularly, the invention relates to a method, a controller system, and a computer program for controlling a software-defined network “SDN”.

### BACKGROUND

Software-defined networking is an emerging architecture for data transfer networks. In a software-defined network “SDN”, the control plane is separated from the data plane so that the control plane is implemented in one or more controllers that can be separate from the network elements and the data plane is implemented in the network elements. The network elements can be, for example, Internet Protocol “IP” routers, multiprotocol label switching “MPLS” nodes, packet optical switches, and/or Ethernet switches. Each network element may consist of a single apparatus or a combination of a plurality of apparatuses. Typically, the software-defined networking allows for quick experimenting and optimization of switching and/or routing policies and external access to the innards of network elements that formerly were closed and proprietary.

Internet Protocol “IP” based networks were initially built based on the concept of Autonomous Systems “AS”. This concept allows networks to scale and extend by connected junctions that forward packets to a reasonable next hop based on partial need-to-know information. The AS principle works much like the traditional post office service, where a postal worker in a given city does not need to know all the tenants of all the streets in another city in order to choose a reasonable next hop for a letter at hand. This approach to networking is simple, and has proven resilient and scalable. This approach has, however, a few drawbacks. It does not allow the designated destinations, or tenants with home mail-boxes, to move without changing their identity as far as the packet delivery service is concerned. The topological location of destinations, which is the network interface they are attached to, dictates their identity related to the packet delivery service. In addition, using only the basic AS principle, it is hard to specify other qualities, such as logical grouping, access control, quality of service, intermediate network processing, or to specify aspects that relate to a sequence of packets that form a flow.

Using the analogy of the postal service, the software-defined networking works, for any given street location, so that all the letters from all the tenants would first be aggregated by a network element on an edge a software-defined network. This network element is configured to examine the current location for each of the letter-destinations using a global lookup mechanism. Based on that global lookup and on other globally defined and globally measured considerations, such as access control or remote location load conditions, the said network element places one or more of the original letters in an additional envelope addressed to each of the street locations where the destinations currently are. It then uses the normal postal service which works like the traditional Internet Protocol “IF” to get these outer envelopes to the remote locations. This is done based on the existing and scalable hop-by-hop forwarding services. The outer letters are then opened by a remote network element and the original envelopes are delivered to the destinations. It is to be noted that the above-presented analogy between the software-defined networking and the postal service is a strong simplification and it gives only a limited viewpoint about the versatile possibilities provided by the software-defined networking.

The software-defined networking is, however, not free from challenges. Some of the challenges are related to a need to control a software-defined network so that it is constantly capable of providing desired services with sufficiently high quality. Therefore, there is still a need for technical solutions for configuring software-defined networks.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In accordance with the invention, there is provided a new method for controlling a software-defined network. A method according to the invention comprises:
receiving information provided by one or more external sources outside the software-defined network,
generating configuration data for changing configuration of one or more network elements of the software-defined network on the basis of the received information in response to a situation in which the received information indicates an occurred or forthcoming change of one or more operating conditions of the software-defined network, and
sending, to the one or more network elements of the software-defined network, the configuration data so as to adapt the software-defined network to the occurred or forthcoming change of the one or more operating conditions of the software-defined network.

In the above-described method, the configuration capabilities provided by the software-defined networking are utilized for dynamically optimizing the software-defined network with respect to changes that are not necessarily indicated by information gatherable inside the software-defined network but by information provided by the external sources outside the software-defined network. A method according to an exemplifying and non-limiting embodiment of the invention further comprises receiving information gathered inside the software-defined network and dynamically optimizing the software-defined network with respect to also changes that are indicated by the information gathered inside the software-defined network.

In accordance with the invention, there is provided also a new controller system for configuring a software-defined network. The controller system can be a single apparatus or a combination of a plurality of apparatuses capable of communicating with each other. A controller system according to the invention comprises a processing system and a data transfer interface for receiving information provided by one or more external sources outside the software-defined network, wherein the processing system is adapted to:
generate configuration data for changing configuration of one or more network elements of the software-defined network on the basis of the received information in response to a situation in which the received information indicates an occurred or forthcoming change of one or more operating conditions of the software-defined network, and
control the data transfer interface to send the configuration data to the one or more network elements of the software-defined network so as to adapt the software-defined network to the occurred or forthcoming change of the one or more operating conditions of the software-defined network.

In accordance with the invention, there is provided also a new software-defined network that comprises one or more network elements and a controller system according to the invention for controlling the one or more network elements. It is to be noted that the controller system or one or more parts of it can also act as one or more network elements that can be e.g. an Internet Protocol “IP” router, a multi-protocol label switching “MPLS” node, a packet optical switch, and/or an Ethernet switch.

In accordance with the invention, there is provided also a new computer program for controlling a software-defined network. A computer program according to the invention comprises computer executable instructions for controlling a programmable processing system to:
generate configuration data for changing configuration of one or more network elements of the software-defined network on the basis of information provided by one or more external sources outside the software-defined network in response to a situation in which the information indicates an occurred or forthcoming change of one or more operating conditions of the software-defined network, and
control a data transfer interface to send, to the one or more network elements of the software-defined network, the first configuration data so as to adapt the software-defined network to the occurred or forthcoming change of the one or more operating conditions of the software-defined network.

In accordance with the invention, there is provided also a new computer program product. The computer program product comprises a non-volatile computer readable medium, e.g. a compact disc “CD”, encoded with a computer program according to the invention.

A number of exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying embodiments when read in connection with the accompanying drawings.

The verbs “to comprise” and “to include” are used in this document as open limitations that neither exclude nor require the existence of also un-recited features. The features recited in depending claims are mutually freely combinable unless otherwise explicitly stated.

### BRIEF DESCRIPTION OF THE FIGURES

The exemplifying and non-limiting embodiments of the invention and their advantages are explained in greater detail below with reference to the accompanying drawings, in which:

FIG. 1 shows a schematic illustration of a software-defined network according to an exemplifying embodiment of the invention,

FIG. 2 shows a schematic illustration of a controller system according to an exemplifying embodiment of the invention for controlling a software-defined network, and

FIG. 3 shows a flow chart of a method according to an exemplifying embodiment of the invention for configuring a network element of a software-defined network.

### DESCRIPTION OF EXEMPLIFYING EMBODIMENTS

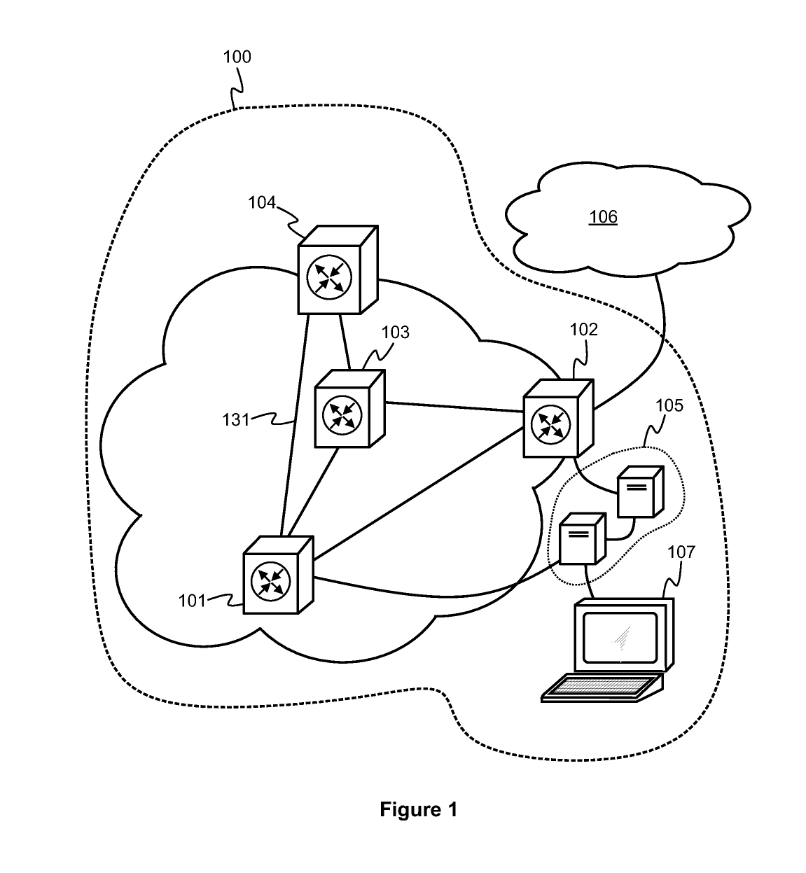

FIG. 1 shows a schematic illustration of a software-defined network “SDN” 100 according to an exemplifying embodiment of the invention. The software-defined network comprises network elements 101, 102, 103, and 104 and a controller system 105. The network elements 101-104 of this exemplifying software-defined network are mutually interconnected with data transfer links as illustrated in FIG. 1. Furthermore, the exemplifying software-defined network “SDN” 100 may comprise other network elements that are not shown in FIG. 1. The network elements may be e.g. Internet Protocol “IP” routers, multiprotocol label switching “MPLS” nodes, packet optical switches, and/or Ethernet switches. Each network element may consist of a single apparatus or a combination of a plurality of apparatuses. As well, the controller system 105 may consist of a single apparatus or a combination of a plurality of apparatuses. In the exemplifying case illustrated in FIG. 1, the controller system 105 comprises two interconnected apparatuses. A terminal device 107 is connected to the controller system 105 and the network element 102 acts as a gateway to an external network 106 that can be e.g. the global Internet. The controller system 105 comprises a data transfer interface for receiving data from the terminal device 107 and/or from one or more other devices connected with data transfer links to the data transfer interface of the controller system. It is to be noted that the controller system 105 or one or more parts of it can also act as one or more network elements that can be e.g. an Internet Protocol “IP” router, a multiprotocol label switching “MPLS” node, a packet optical switch, and/or an Ethernet switch.

Each of the network elements 101-104 comprises a control processor section for maintaining a look-up system that comprises at least one look-up table defining actions to be executed in conjunction with managing data frames, and a data forwarding section for managing the data frames in accordance with the look-up system. The at least one look-up table of the look-up system may comprise, for example but not necessarily, one or more successive flow tables and a group table according to the OpenFlow specification. The OpenFlow is managed by the Open Networking Foundation “ONF”. In the exemplifying case where the OpenFlow is used, each flow table in a network element contains a set of flow entries. Each flow entry may consist of match fields, counters, and a set of actions to apply to matching data frames. Matching typically starts at the first flow table and may continue to additional flow tables. Flow entries can be arranged into a priority order and the first matching entry in each table is the one being used. If a matching flow entry is found, the one or more actions associated with this specific flow entry are executed. If no match is found in a flow table, the data frame may be forwarded to the controller system 105 over an OpenFlow channel between the network element under consideration and the controller system 105, the data frame may be dropped, or the data frame may continue to the next flow table or to the group table. Actions associated with each flow entry may comprise for example data frame forwarding, data frame modification, group table processing, and pipeline processing. Pipeline processing actions allow data frames to be sent to subsequent flow tables for further processing and allow information, in the form of metadata, to be communicated between the flow tables. Table pipeline processing stops when the one or more actions associated with a matching flow entry does not specify a next table. At this point the data frame under consideration is usually modified and forwarded. The group table processing actions allow data frames to be sent to the group table for further processing and allow information, in the form of metadata, to be communicated to the group table. The group table contains group entries, where each group entry may contain a list of actions to be directed to data frames defined to belong to a particular group.

The controller system 105 is adapted to send, to each of the network elements 101-104, configuration data that comprises data items for configuring the network element to maintain the look-up system in accordance with, for example, a pre-determined collection of actions defined by a protocol, e.g. the OpenFlow, for configuring the network elements. Furthermore, the configuration data may comprise one or more configuration programs each of which comprising one or more computer executable instructions defining an action or a chain of actions to be executed in conjunction with managing data frames in the network element under consideration. The control processor section of each of the network elements 101-104 can be adapted to associate each configuration program to the one or more look-up tables of the look-up system so that the configuration program is callable to be executed in conjunction with managing data frames with the aid of the one or more look-up tables. The data forwarding section of each of the network elements 101-104 can be adapted to execute the action or the chain of actions defined by the configuration program in response to a situation in which the managing a particular data frame includes an order to execute the configuration program. The action or the chain of actions defined by the configuration program may comprise for example: reading data from a data frame, modifying the data frame, selecting one or more of egress ports of the network element and forwarding the data frame and its possible duplicates to the selected one or more egress ports, selecting one of the look-up tables maintained by the network element and executing a look-up from the selected look-up table, performing arithmetic operations, branching operations, performing logical operations, reading metadata associated with the data frame, writing metadata associated with the data frame, modifying metadata associated with the data frame, dropping the data frame, and/or duplicating the data frame.

The controller system 105 is adapted to receive first information provided by one or more external sources outside the software-defined network 100. The first information can be received, for example, from or via the external network 106 or from the terminal device 107. The controller system 105 is adapted to generate first configuration data for changing configuration of one or more of the network elements 101-104 on the basis of the first information in response to a situation in which the first information indicates an occurred or forthcoming change of one or more operating conditions of the software-defined network 100. The algorithm for generating the first configuration data can be, for example, a heuristic algorithm based on experience and it can be implemented with the aid of a pre-stored collection of configuration data elements which are suitable for different operating conditions. It is also possible that techniques such as e.g. neural networks and/or fuzzy logics are used as a basis of the algorithm for generating the first configuration data. The controller system 105 is further adapted to send, to the one or more of the network elements 101-105, the first configuration data so as to adapt the software-defined network 100 to the occurred or forthcoming change of the one or more operating conditions. The above-mentioned first information may indicate, for example, geographical distribution of the user population of the software-defined network 100. In this case, the controller system 105 is advantageously is adapted to generate the first configuration data for reconfiguring routing topology of at least a part of the software-defined network 100 and/or data management policy of one or more of the network elements 101-104 on the basis of changes of the geographical distribution of the user population. In the above-mentioned exemplifying case, the changes of the geographical distribution of the user population represent the occurred or forthcoming change of the one or more operating condition of the software-defined network 100.

On the geographical service area of the software-defined network 100, there can be, for example, concerts, festivals or other happenings, or traffic jams which may concentrate the user population on certain geographical areas and this may increase the current and/or foreseeable loading of those network elements that serve these geographical areas and/or the current and/or foreseeable loads of data transfer links connecting to these network elements. In an exemplifying case, the user population can be concentrated so that the current and/or foreseeable loading of e.g. the network element 101 is increased. In this exemplifying case, the routing topology of the software defined network 100 is advantageously changed so that e.g. a greater relative portion of data traffic between the network elements 102 and 104 gets routed via the network element 103 and, correspondingly, a smaller relative portion of this data traffic gets routed via the network element 101 so as to reduce the loading of the network element 101. Furthermore, the data management policy of one or more of the network elements 102-104 can be changed so that lower service class data traffic is no more forwarded via the network element 101 or the lower service class data traffic is limited more harshly before it is directed to the network element 101.

For another example, the above-mentioned first information provided by one or more external sources may indicate physical operating conditions of one or more data transfer links of the software defined network 100. In this case, the controller system 105 is advantageously is adapted to generate the first configuration data for reconfiguring the routing topology of at least a part of the software-defined network 100 and/or the data management policy of one or more of the network elements 101-104 on the basis of changes of the physical operating conditions. In this exemplifying case, the changes of the physical operating conditions of the data transfer links represent the occurred or forthcoming change of the one or more operating conditions of the software-defined network 100. The physical operating conditions may relate for example to forecast or current weather or to circumstances caused by man e.g. external radio signals emitted by devices outside the software defined network 100. In an exemplifying case, the direct data transfer link 131 between the network elements 101 and 104 can be radio link whose throughput is dependent on weather so that the throughput is smaller when it is raining than when there is dry weather. Furthermore, the throughput can be dependent on external radio signals on the frequency band of the data transfer link 131. In this exemplifying case, the routing topology of the software defined network 100 is advantageously changed so that a smaller relative portion of data traffic between the network elements 101 and 104 gets routed through the direct data transfer link 131 and, correspondingly, a greater relative portion of this data traffic gets routed via the network element 103 when, for example, it is raining or there is a forecast for rain so as to relieve the negative impact of rain on the quality of service.

Furthermore, the above-mentioned first information provided by one or more external sources may indicate forthcoming maintenance and/or management actions of an operator, and/or current and/or predicted activities of users. In this case, the controller system 105 is advantageously is adapted to generate the first configuration data for reconfiguring the routing topology of at least a part of the software-defined network 100 and/or the data management policy of one or more of the network elements 101-104 on the basis of the forthcoming maintenance and management actions of the operator, and/or the current and/or predicted activities of the users.

In a software-defined network according to an exemplifying embodiment of the invention, the controller system 105 is further adapted to receive second information gathered from the software-defined network 101. One or more of the network elements 101-104 can be adapted to analyze data traffic using, for example but not necessarily, deep packet inspection “DPI” and traffic counters and to send the information inspected to the controller system 105 or to some other data collection entity that is capable of interfacing with the controller system 105. One or more of the network elements 101-104 can as well send other data including for example time, user data e.g. in a form of anonymized aggregates, delay and loss measurements on data transfer links, upper layer metrics, e.g. metrics relevant to connectivity between a Radio Network Controller “RNC” and a node-B, routing and signaling protocol events and/or actions of the operator. In some cases, the upper layer metrics may be provided by one or more external sources outside the software-defined network 100 and/or by such devices within the software-defined network 100 that are not under the control of the controller system 105.

The controller system 105 can be adapted to generate second configuration data for changing configuration of one or more of the network elements 101-104 of the software-defined network 100 on the basis of the second information gathered from the software-defined network in response to a situation in which the second information indicates an occurred or forthcoming change in the software-defined network. Furthermore, the controller system 105 is adapted to send, to the one or more of the network elements 101-104, the second configuration data so as to adapt the software-defined network to the occurred or forthcoming change indicated by the second information. For a further example, the second information gathered from the software-defined network 101 can be related to trouble shooting. Based on the gathered data the controller system 105 can force handover from one network element or data transfer link to another network element or data transfer link just before a forecasted crash or service degradation due to a predicted failure.

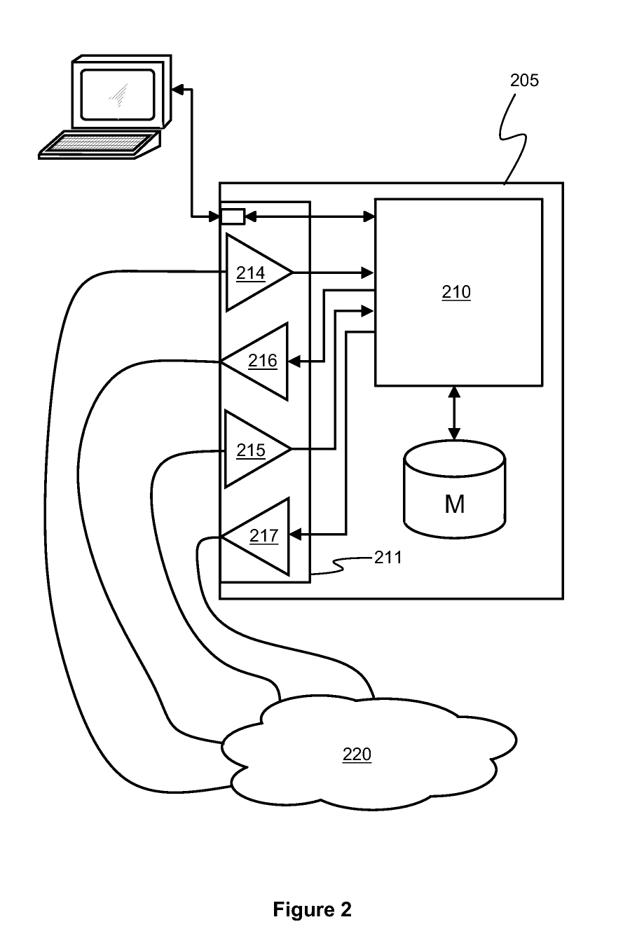

FIG. 2 shows a schematic illustration of a controller system 205 according to an exemplifying embodiment of the invention for controlling a software-defined network “SDN”. In this exemplifying case, the controller system is a single apparatus but, as mentioned earlier in this document, the controller system could as well be a combination of a plurality of apparatuses. The controller system comprises a data transfer interface 211 for receiving data and for transmitting data. The data transfer interface 211 comprises ingress ports 214 and 215 and egress ports 216 and 217 for connecting via data transfer links to a data transfer network 220. The data transfer interface 211 is suitable for receiving first information provided by one or more external sources outside the software-defined network. The controller system 205 comprises means for generating first configuration data for changing configuration of one or more network elements of the software-defined network on the basis of the first information in response to a situation in which the first information indicates an occurred or forthcoming change of one or more operating conditions of the software-defined network. The controller system 205 comprises means for controlling the data transfer interface 211 to send, to the one or more network elements of the software-defined network, the first configuration data so as to adapt the software-defined network to the occurred or forthcoming change of the one or more operating conditions. In the exemplifying case illustrated in FIG. 2, the above-mentioned means are implemented with a processing system 210.

In a controller system according to an exemplifying embodiment of the invention, the first information indicates geographical distribution of user population of the software-defined network and the processing system 210 is adapted to generate the first configuration data for adapting the software-defined network to changes of the geographical distribution of the user population of the software-defined network.

In a controller system according to an exemplifying embodiment of the invention, the processing system 210 is adapted to generate the first configuration data for reconfiguring at least one of the following on the basis of the changes of the geographical distribution of the user population: routing topology of at least a part of the software-defined network, data management policy of one or more of the network elements of the software-defined network.

In a controller system according to an exemplifying embodiment of the invention, the first information indicates physical operating conditions of one or more data transfer links and the processing system 210 is adapted to generate the first configuration data for adapting the software-defined network to changes of the physical operating conditions of the one or more data transfer links.

In a controller system according to an exemplifying embodiment of the invention, the processing system 210 is adapted to generate the first configuration data for reconfiguring at least one of the following on the basis of the changes of the physical operating conditions of the one or more data transfer links: routing topology of at least a part of the software-defined network, data management policy of one or more of the network elements of the software-defined network.

In a controller system according to an exemplifying embodiment of the invention, the processing system 210 is further adapted to:
receive second information gathered from the software-defined network,
generate second configuration data for changing configuration of the one or more network elements of the software-defined network on the basis of the second information in response to a situation in which the second information indicates an occurred or forthcoming change in the software-defined network, and
send, to the one or more network elements of the software-defined network, the second configuration data so as to adapt the software-defined network to the occurred or forthcoming change indicated by the second information.

In a controller system according to an exemplifying embodiment of the invention, the second information indicates loading of the software-defined network and the processing system 210 is adapted to generate the second configuration data for adapting the software-defined network to changes of the loading of the software-defined network.

In a controller system according to an exemplifying embodiment of the invention, the processing system 210 is adapted to generate the second configuration data for reconfiguring at least one of the following on the basis of the changes of the loading of the software-defined network: routing topology of at least a part of the software-defined network, data management policy of one or more of the network elements of the software-defined network.

In a controller system according to an exemplifying embodiment of the invention, the second information indicates measured quality of service provided by the software-defined network and the processing system 210 is adapted to generate the second configuration data for adapting the software-defined network to changes of the measured quality of service. The quality of service can be expressed with the aid of e.g. data transfer delays, data loss ratios, and/or jitter and/or wander of data transfer delays.

In a controller system according to an exemplifying embodiment of the invention, the processing system 210 is adapted to generate the second configuration data for reconfiguring at least one of the following on the basis of the changes of the measured quality of service: routing topology of at least a part of the software-defined network, data management policy of one or more of the network elements of the software-defined network.

The processing system 210 of the controller system shown in FIG. 2 can be implemented with one or more processor circuits, each of which can be a programmable processor circuit provided with appropriate software, a dedicated hardware processor such as, for example, an application specific integrated circuit “ASIC”, or a configurable hardware processor such as, for example, a field programmable gate array “FPGA”.

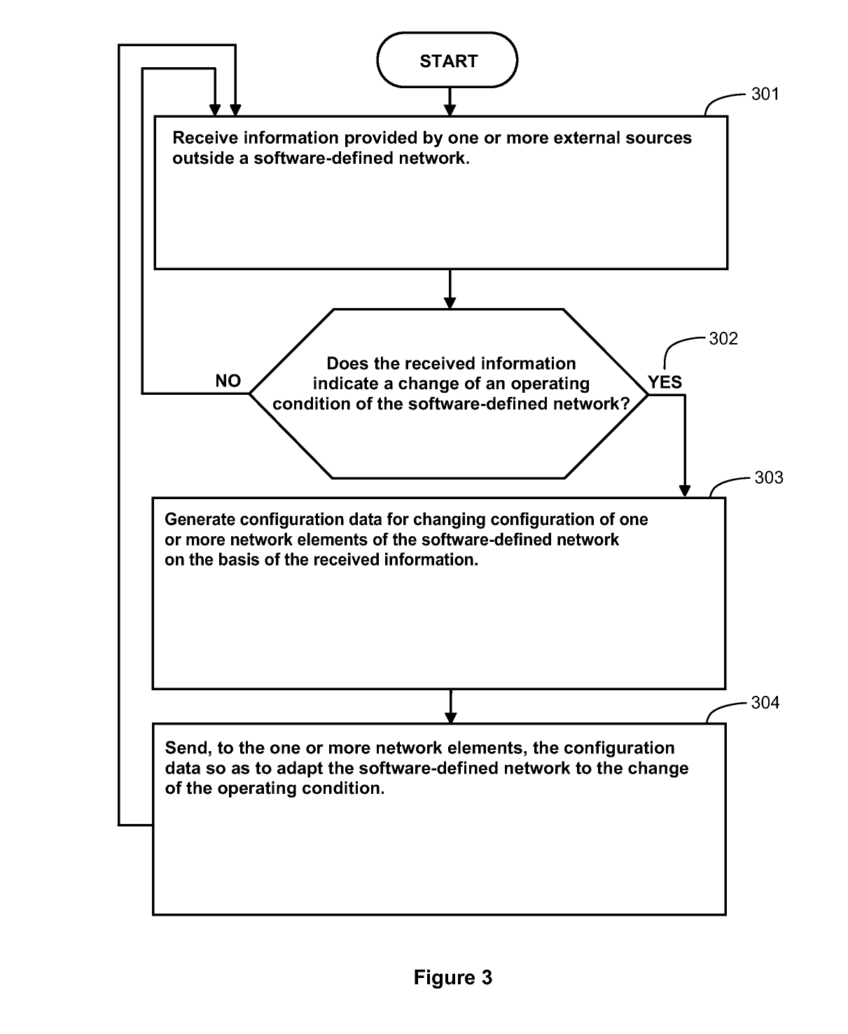

FIG. 3 shows a flow chart of a method according to an exemplifying embodiment of the invention for controlling a software-defined network. The method comprises the following actions:
action 310: receiving first information provided by one or more external sources outside the software-defined network,
action 303: generating first configuration data for changing configuration of one or more network elements of the software-defined network on the basis of the first information in response to a situation 302 in which the first information indicates an occurred or forthcoming change of one or more operating conditions of the software-defined network, and
action 304: sending, to the one or more network elements of the software-defined network, the first configuration data so as to adapt the software-defined network to the occurred or forthcoming change of the one or more operating conditions of the software-defined network.

In a method according to an exemplifying embodiment of the invention, the first information indicates geographical distribution of user population of the software-defined network and the first configuration data is generated for adapting the software-defined network to changes of the geographical distribution of the user population of the software-defined network.

In a method according to an exemplifying embodiment of the invention, the first configuration data is generated for reconfiguring at least one of the following on the basis of the changes of the geographical distribution of the user population: routing topology of at least a part of the software-defined network, data management policy of one or more of the network elements of the software-defined network.

In a method according to an exemplifying embodiment of the invention, the first information indicates physical operating conditions of one or more data transfer links and the first configuration data is generated for adapting the software-defined network to changes of the physical operating conditions of the one or more data transfer links.

In a method according to an exemplifying embodiment of the invention, the first configuration data is generated for reconfiguring at least one of the following on the basis of the changes of the physical operating conditions of the one or more data transfer links: routing topology of at least a part of the software-defined network, data management policy of one or more of the network elements of the software-defined network.

A method according to an exemplifying embodiment of the invention further comprises:
receiving second information gathered from the software-defined network,
generating second configuration data for changing configuration of the one or more network elements of the software-defined network on the basis of the second information in response to a situation in which the second information indicates an occurred or forthcoming change in the software-defined network, and
sending, to the one or more network elements of the software-defined network, the second configuration data so as to adapt the software-defined network to the occurred or forthcoming change indicated by the second information.

In a method according to an exemplifying embodiment of the invention, the second information indicates loading of the software-defined network and the second configuration data is generated for adapting the software-defined network to changes of the loading of the software-defined network.

In a method according to an exemplifying embodiment of the invention, the second configuration data is generated for reconfiguring at least one of the following on the basis of the changes of the loading of the software-defined network: routing topology of at least a part of the software-defined network, data management policy of one or more of the network elements of the software-defined network.

In a method according to an exemplifying embodiment of the invention, the second information indicates measured quality of service provided by the software-defined network and the second configuration data is generated for adapting the software-defined network to changes of the measured quality of service.

In a method according to an exemplifying embodiment of the invention, the second configuration data is generated for reconfiguring at least one of the following on the basis of the changes of the measured quality of service: routing topology of at least a part of the software-defined network, data management policy of one or more of the network elements of the software-defined network.

A computer program according to an exemplifying embodiment of the invention for controlling a software-defined network comprises computer executable instructions for controlling a programmable processing system to carry out a method according to any of the above-described exemplifying embodiments of the invention.

A computer program according to an exemplifying embodiment of the invention comprises software modules for controlling a software-defined network. The software modules comprise computer executable instructions for controlling a programmable processing system to:
generate first configuration data for changing configuration of one or more network elements of the software-defined network on the basis of information provided by one or more external sources outside the software-defined network in response to a situation in which the information indicates an occurred or forthcoming change of one or more operating conditions of the software-defined network, and
control a data transfer interface to send, to the one or more network elements of the software-defined network, the first configuration data so as to adapt the software-defined network to the occurred or forthcoming change of the one or more operating conditions of the software-defined network.

The software modules can be e.g. subroutines or functions implemented with a suitable programming language and with a compiler suitable for the programming language and the programmable processing system.

A computer program product according to an exemplifying embodiment of the invention comprises a computer readable medium, e.g. a compact disc (“CD”), encoded with a computer program according to an exemplifying embodiment of invention.

A signal according to an exemplifying embodiment of the invention is encoded to carry information defining a computer program according to an exemplifying embodiment of invention.

The specific examples provided in the description given above should not be construed as limiting the scope and/or the applicability of the appended claims.

What is claimed is:

1. A controller system for controlling a software-defined network, the controller system comprising a processing system and a data transfer interface for receiving first information provided by one or more external sources outside the software-defined network, wherein the processing system is adapted to:
generate first configuration data for changing configuration of one or more network elements of the software-defined network on the basis of the first information in response to a situation in which the first information indicates an occurred or forthcoming change of one or more operating conditions of the software-defined network, and
control the data transfer interface to send the first configuration data to the one or more network elements of the software-defined network so as to adapt the software-defined network to the occurred or forthcoming change of the one or more operating conditions of the software-defined network.

2. A controller system according to claim 1, wherein the processing system is further adapted to:
receive second information gathered from the software-defined network,
generate second configuration data for changing configuration of the one or more network elements of the software-defined network on the basis of the second information in response to a situation in which the second information indicates an occurred or forthcoming change in the software-defined network, and
send, to the one or more network elements of the software-defined network, the second configuration data so as to adapt the software-defined network to the occurred or forthcoming change indicated by the second information.

3. A controller system according to claim 1, wherein the first information indicates geographical distribution of user population of the software-defined network and the processing system is adapted to generate the first configuration data for adapting the software-defined network to changes of the geographical distribution of the user population of the software-defined network.

4. A controller system according to claim 3, wherein the processing system is adapted to generate the first configuration data for reconfiguring at least one of the following on the basis of the changes of the geographical distribution of the user population: routing topology of at least a part of the software-defined network, data management policy of one or more of the network elements of the software-defined network.

5. A controller system according to claim 1, wherein the first information indicates physical operating conditions of one or more data transfer links and the processing system is adapted to generate the first configuration data for adapting the software-defined network to changes of the physical operating conditions of the one or more data transfer links.

6. A controller system according to claim 5, wherein the processing system is adapted to generate the first configuration data for reconfiguring at least one of the following on the basis of the changes of the physical operating conditions of the one or more data transfer links: routing topology of at least a part of the software-defined network, data management policy of one or more of the network elements of the software-defined network.

7. A controller system according to claim 2, wherein the second information indicates loading of the software-defined network and the processing system is adapted to generate the second configuration data for adapting the software-defined network to changes of the loading of the software-defined network.

8. A controller system according to claim 7, wherein the processing system is adapted to generate the second configuration data for reconfiguring at least one of the following on the basis of the changes of the loading of the software-defined network: routing topology of at least a part of the software-defined network, data management policy of one or more of the network elements of the software-defined network.

9. A controller system according to claim 2, wherein the second information indicates measured quality of service provided by the software-defined network and the processing system is adapted to generate the second configuration data for adapting the software-defined network to changes of the measured quality of service.

10. A controller system according to claim 9, wherein the processing system is adapted to generate the second configuration data for reconfiguring at least one of the following on the basis of the changes of the measured quality of service: routing topology of at least a part of the software-defined network, data management policy of one or more of the network elements of the software-defined network.

11. A method for controlling a software-defined network, the method comprising:
receiving first information provided by one or more external sources outside the software-defined network,
generating first configuration data for changing configuration of one or more network elements of the software-defined network on the basis of the first information in response to a situation in which the first information indicates an occurred or forthcoming change of one or more operating conditions of the software-defined network, and
sending, to the one or more network elements of the software-defined network, the first configuration data so as to adapt the software-defined network to the occurred or forthcoming change of the one or more operating conditions of the software-defined network.

12. A method according to claim 11, wherein the method further comprises:
receiving second information gathered from the software-defined network,
generating second configuration data for changing configuration of the one or more network elements of the software-defined network on the basis of the second information in response to a situation in which the second information indicates an occurred or forthcoming change in the software-defined network, and
sending, to the one or more network elements of the software-defined network, the second configuration data so as to adapt the software-defined network to the occurred or forthcoming change indicated by the second information.

13. A method according to claim 11, wherein the first information indicates geographical distribution of user population of the software-defined network and the first configuration data is generated for adapting the software-defined network to changes of the geographical distribution of the user population of the software-defined network.

14. A method according to claim 13, wherein the first configuration data is generated for reconfiguring at least one of the following on the basis of the changes of the geographical distribution of the user population: routing topology of at least a part of the software-defined network, data management policy of one or more of the network elements of the software-defined network.

15. A method according to claim 11, wherein the first information indicates physical operating conditions of one or more data transfer links and the first configuration data is generated for adapting the software-defined network to changes of the physical operating conditions of the one or more data transfer links.

16. A method according to claim 15, wherein the first configuration data is generated for reconfiguring at least one of the following on the basis of the changes of the physical operating conditions of the one or more data transfer links: routing topology of at least a part of the software-defined network, data management policy of one or more of the network elements of the software-defined network.

17. A method according to claim 12, wherein the second information indicates loading of the software-defined network and the second configuration data is generated for adapting the software-defined network to changes of the loading of the software-defined network.

18. A method according to claim 17, wherein the second configuration data is generated for reconfiguring at least one of the following on the basis of the changes of the loading of the software-defined network: routing topology of at least a part of the software-defined network, data management policy of one or more of the network elements of the software-defined network.

19. A method according to claim 12, wherein the second information indicates measured quality of service provided by the software-defined network and the second configuration data is generated for adapting the software-defined network to changes of the measured quality of service.

20. A method according to claim 19, wherein the second configuration data is generated for reconfiguring at least one of the following on the basis of the changes of the measured quality of service: routing topology of at least a part of the software-defined network, data management policy of one or more of the network elements of the software-defined network.

21. A non-transitory computer readable medium encoded with a computer program for controlling a software-defined network, the computer program comprising computer executable instructions for controlling a programmable processing system to:
generate first configuration data for changing configuration of one or more network elements of the software-defined network on the basis of first information provided by one or more external sources outside the software-defined network in response to a situation in which the first information indicates an occurred or forthcoming change of one or more operating conditions of the software-defined network, and
control a data transfer interface to send, to the one or more network elements of the software-defined network, the first configuration data so as to adapt the software-defined network to the occurred or forthcoming change of the one or more operating conditions of the software-defined network.

22. A software-defined network comprising:
one or more network elements, and
a controller system for controlling the one or more network elements,
wherein the controller system comprises a data transfer interface for receiving first information provided by one or more external sources outside the software-defined network, and a processing system adapted to:
generate first configuration data for changing configuration of the one or more network elements of the software-defined network on the basis of the first information in response to a situation in which the first information indicates an occurred or forthcoming change of one or more operating conditions of the software-defined network, and
control the data transfer interface to send the first configuration data to the one or more network elements of the software-defined network so as to adapt the software-defined network to the occurred or forthcoming change of the one or more operating conditions of the software-defined network.

23. A software-defined network according to claim 22, wherein the controller system is configured to use the OpenFlow as a communication method for a control plane of the software-defined network to communicate with a data plane of the software-defined network.
